(19) United States
(12) Patent Application Publication
(10) Pub. No.: US 2026/0339868 A1
(43) Pub. Date: Oct. 29, 2026

(54) SOFTWARE DEFINED RACK

(71) Applicant: Microsoft Technology Licensing, LLC, Redmond, WA (US)

(72) Inventors: Shuotao XU, Shanghai (CN); Peng CHENG, Beijing (CN); Yuqing YANG, Shanghai (CN); Derek Tsungkai CHIOU, Austin, TX (US); Mark Donald HILL, Menlo Park, CA (US); Ran SHU, Beijing (CN); Ziyue YANG, Beijing (CN); Lei QU, Beijing (CN); Yongqiang XIONG, Beijing (CN)

(21) Appl. No.: 19/119,752

(22) PCT Filed: Nov. 9, 2022
(86) PCT No.: PCT/CN2022/130915

§ 371 Date: Apr. 9, 2025

(51) Int. Cl. G06F 13/40; G06F 11/14

(52) U.S. Cl. CPC G06F 13/4022; G06F 11/1423; G06F 2213/0026

(57) ABSTRACT

Embodiments of the present disclosure include techniques for managing partitions of hardware resources in a computer system. In one embodiment, the present disclosure includes a plurality of processors and a plurality of peripheral devices coupled together over a switch fabric. A host for a partition may include a driver and a registry. An OS and the driver may communicate with the registry. State information stored in the driver and registry may be coordinated to recover from link failures and other path changes in the partition, for example.

### BACKGROUND

The present disclosure relates generally to computing, and in particular, to software defined partitions of compute resources.

Contemporary computer systems typically include server computers comprising one or more processors coupled to peripheral devices over a dedicated bus. Multiple servers may be placed in racks (i.e., physical structures to hold the circuit boards). Virtualization technologies may run on top of such physical computer structures. With the growth and cost of compute demands, it would be desirable to have more flexibility in how processors and other compute resources are interconnected to perform various functions.

The present disclosure addresses these and other issues.

### BRIEF DESCRIPTION OF THE DRAWINGS

FIG. 1 illustrates a partitioning processors and peripherals according to an embodiment.

FIG. 2 illustrates a method of configuring partitioned devices according to an embodiment.

FIG. 3 illustrates an example partition and software system according to an embodiment.

FIG. 4 illustrates an example registry according to an embodiment.

FIG. 5 depicts a simplified block diagram of an example system according to some embodiments.

FIG. 6 illustrates an example device allocation process according to an embodiment.

FIG. 7 illustrates an example link failure recovery process according to an embodiment.

### DETAILED DESCRIPTION

Described herein are techniques for software defined racks. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Features and advantages of the present disclosure include a software defined rack system where multiple processors and peripheral devices are connected together over a high speed off-chip switch fabric. The system may be partitioned into different compute domains as defined by software. One or more processors and one or more peripheral devices may be in each domain for example. Different domains may be configured by software to have different numbers of processors and different numbers and types of peripheral devices according to unique user application requirements, for example.

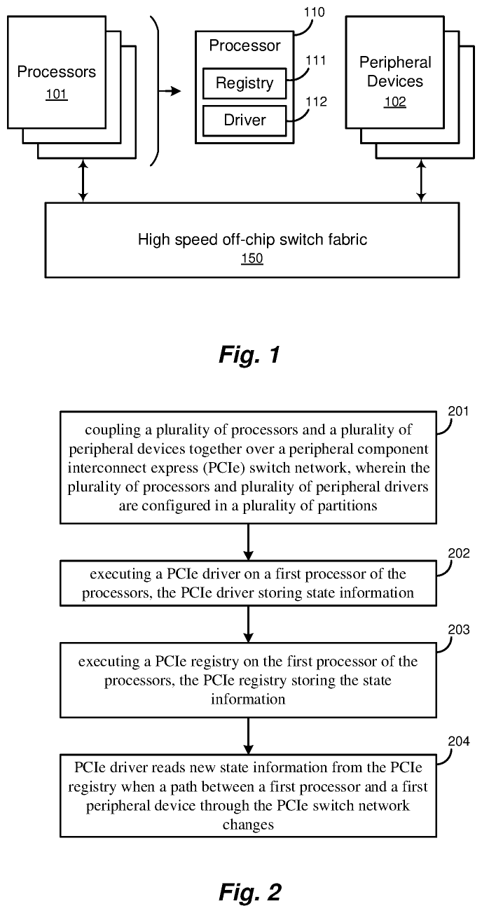

FIG. 1 illustrates a computer system for partitioning processors and peripherals according to an embodiment. In FIG. 1, a plurality of processors 101 and a plurality of peripheral devices 102 are coupled together over high speed off-chip switch fabric 150.

Processors 101 may include x86 processors, ARM processors, artificial intelligence or machine learning optimized processors, or a variety of other types of processors, and may be directly coupled to random access memories (RAM) over high speed memory buses (not shown). As known by those skilled in the art, x86 processors are a class of central processing units (CPUs) produced by Intel® and AMD®, for example, and ARM processors are a class of CPUs based on a reduced instruction set computer (RISC) architecture (ARM typically stands for Advanced RISC Machine). Peripheral devices may include solid state memory devices (SSDs), field programmable gate arrays (FPGAs), and/or graphics processing units (GPUs), for example. Switch fabric 150 may be a peripheral component interconnect express (PCIe) switch network comprising a plurality of PCIe switches arranged in a variety of configurations to move data between any of the devices connected to the network, for example.

Features and advantages of the present disclosure include a PCIe registry 111 and a PCIe driver 112 executing one or more of the processors. While registry 111 and driver 112 are shown here executing on processor 110, it is to be understood that these software components may execute on different processors in some embodiments. PCIe driver 112 stores state information (aka, driver context). Generally, a driver is a software component that allows the operating system (OS) to communicate with the device (e.g., a PCIe switch fabric system). Driver state information may be information the driver uses to support connectivity over the particular partition the driver belongs to. Accordingly, PCIe driver 112 may include state information for (or relevant to) a particular partition and may store partition specific state information (e.g., relevant to a particular partition configuration of devices).

State information may include, for example, routing information. Routing information may include information specifying paths between different endpoint devices (processors or peripherals) on a switch fabric to implement the partitions.

PCIe registry 111 may also store the state information. As illustrated in more detail below, in some embodiments an operating system managing the partitions of the hardware resources (aka a “Rack OS”) may store driver context in registry 111 and driver 112 may receive driver state information from the registry. Thus, the Rack OS may manage multiple drivers over multiple partitions, for example, and manage the routes between the hardware resources in multiple partitions. For example, when a path between a processor and a peripheral device through switch fabric 150 changes (e.g., a link fails), driver 112 may read new state information from registry 111 to define a new path. As described in more detail below, registry 111 comprises a plurality of routing paths between the processors and peripheral devices.

FIG. 2 illustrates a method of configuring partitioned devices according to an embodiment. In this example, the switch fabric is a PCIe switch network. The PCIe switch network illustrated here is used as an example fabric as those skilled in the art may choose other fabrics for other embodiments. At 201, a plurality of processors and a plurality of peripheral devices are coupled together over a peripheral component interconnect express (PCIe) switch network, wherein the plurality of processors and plurality of peripheral drivers are configured in a plurality of partitions. At 202, a PCIe driver executes on a first processor of the processors, the PCIe driver storing state information. At 203, a PCIe registry executes on the first processor of the processors, the PCIe registry storing the state information. The PCIe registry may receive the state information from a Rack OS, which is then read by the PCIe driver, for example. A 204, the PCIe driver reads new state information from the PCIe registry when a path between a first processor and a first peripheral device through the PCIe switch network changes. The new state information may be received from the Rack OS, for example.

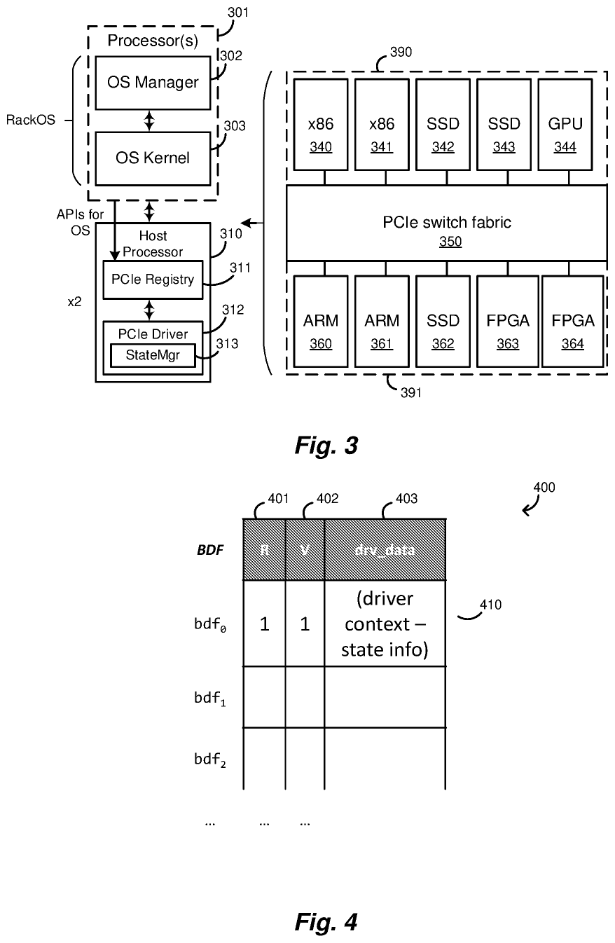

FIG. 3 illustrates an example partition and software system according to an embodiment. In this example, a Rack OS comprises an OS manager 302 and OS kernel 303 executing on one or more processors 301. The Rack OS has created two (2) partitions 390 and 391 of endpoint devices on a PCIe switch fabric 350. Partition 390 comprises two x86 processors 340-341, two SSDs 342-343, and GPU 344. Partition 391 comprises two ARM processors 360-361, SSD 362, and two FPGAs 363-364. Rack OS stores state information in PCIe registry 311, and the state information is read by PCIe driver 312 to control each partition. PCIe registry 311 and PCIe driver 312 may run on the same host processor 310, for example. While only one registry and driver are shown in this example, it is to be understood that there may be two (x2) pairs of registries and drivers-one for each partition.

OS manager 302 may centralize control of device assignments and routing for each partition. For example, OS manager 302 may partition resources into isolated PCIe domains, configure the OS kernel based on partitions definitions, detect failures, manage the failover process, and perform telemetry operations (e.g., hardware status, resource monitoring, etc . . . ).

OS kernel 303 may control device assignments and switch fabric failures by interfacing with partition registries, for example. OS kernel may further allow for virtualization to run on top of the OS (e.g., allowing user applications to run on hardware resources in a particular partition).

Features and advantages of the present disclosure include driver and registry features that support transparent device failover and recovery. In various embodiments, a driver may be extended to include a state manager, which manages driver context. State manager may store driver context in the registry for unplanned driver removal, for example. The state manager may read the context from the registry so the driver can recover when the endpoint resource is back up and running. In this example, PCIe driver 312 includes such a state manager 313. Additionally, the Rack OS may reserve and unreserve registry entries and move driver state information between PCIe bus/device/function (BDF) addresses.

More specifically, the registry may store driver state information (aka context). Context may include software states of the device driver, routing/path information, outstanding requests in the driver that need to be serviced, for example. The Rack OS uses APIs to control the allocation, deallocation, and movement of the driver context. When PCIe device driver 312 initializes, it fetches the driver context from PCIe registry 311, which may include information on how to plug in, how to plug out. Additionally, when a link fails, a PCIe route may be dead, and the path between two endpoint resources may be moved to another route. Accordingly, the Rack OS reconfigures the link. The Rack OS moves the PCIe driver context stored the PCIe registry 311 into the PCIe driver 312.

FIG. 4 illustrates an example registry 400 according to an embodiment. Each entry in registry 400 may correspond to a bus, device, function (BDF) associated with an endpoint (e.g., for read/write). BDF stands for the Bus-Device-Function notation used to describe PCI and PCIe devices (e.g., Bus 0, Device 2, Function 0=00:02.0). Each BDF may define a path through PCIe network to access the remote device. Registry 400 may comprise a plurality of fields 401-403 for storing information related to a particular BDF. In this example, registry 400 includes a reserved field 401 (R) indicating whether or not an entry is reserved for the device, a valid field 402 (V) indicating whether or not an entry is inserted by the driver, and a driver data field 403 storing driver state information (context). Accordingly, PCIe registry 400 comprises a plurality of routing paths between the processors and peripheral devices.

Each routing path may be stored at a unique address in PCIe registry 400. Thus, processors and peripheral devices in each partition may be mapped to the unique addresses in the PCIe registry 400. Reserved field 401 designates that the routing path is reserved. Accordingly, in response to detecting a reserved designation, the routing path may be probed to initialize the PCIe driver, for example. Valid field 402 designates that the routing path is valid or invalid. Accordingly, a valid designation has been initialized by the PCIe driver and an invalid designation has not been initialized by the PCIe driver.

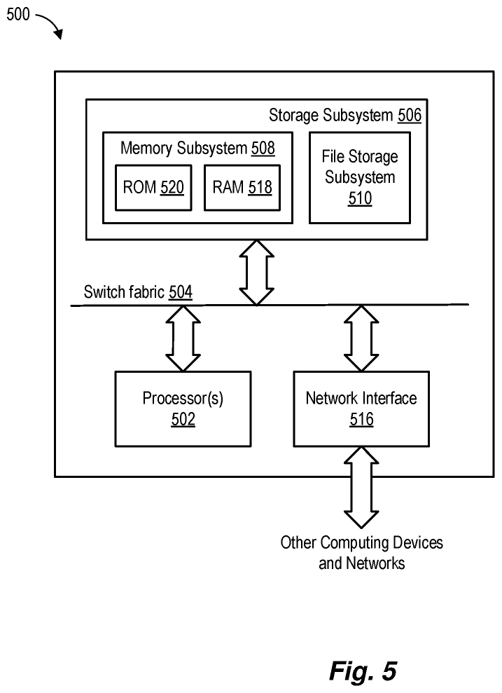

FIG. 5 depicts a simplified block diagram of an example system 500, which can be used to implement the techniques described in the foregoing disclosure. As shown in FIG. 5, system 500 includes one or more processors 502 that communicate with a number of devices via a switch fabrics 504. These devices may include a storage subsystem 506 (e.g., comprising a memory subsystem 508 and a file storage subsystem 510) and a network interface subsystem 516.

Switch fabric 504 can provide a mechanism for letting the various components and subsystems of system 500 communicate with each other as intended. Although switch fabric 504 is shown schematically as a single component, alternative embodiments of the switch fabric can utilize components.

Network interface subsystem 516 can serve as an interface for communicating data between system 500 and other computer systems or networks. Embodiments of network interface subsystem 516 can include, e.g., Ethernet, a Wi-Fi and/or cellular adapter, a modem (telephone, satellite, cable, etc.), and/or the like.

Storage subsystem 506 includes a memory subsystem 508 and a file/disk storage subsystem 510. Subsystems 508 and 510 as well as other memories described herein are examples of non-transitory computer-readable storage media that can store executable program code and/or data that provide the functionality of embodiments of the present disclosure.

Memory subsystem 508 comprise one or more memories including a main random access memory (RAM) 518 for storage of instructions and data during program execution and a read-only memory (ROM) 520 in which fixed instructions are stored. File storage subsystem 510 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 500 is illustrative and many other configurations having more or fewer components than system 500 are possible.

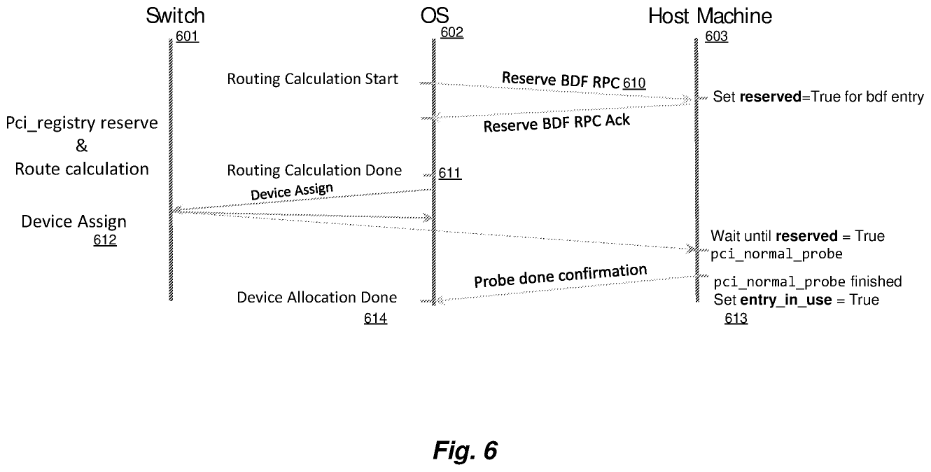

FIG. 6 illustrates an example device allocation process according to an embodiment. For an allocation process, a device is assigned to a machine. Switch 601 performs PCI registry reserves, route calculations, and device assignments. OS 602 interfaces with the switch 601 and host machine 603 running the registry and driver to coordinate the routing information. OS 602 may start a routing calculation and reserve a BDF in a registry on host 603 as shown at 610. Host 610 sets the reserved field in the BDF entry to true and sends and ACK. OS 602 completes the routing calculation at 611 and sends a device assignments message to switch 601. Switch 601 assigns the device at 612. A message is sent to the host to perform a probe of the device. When the probe is finished, the entry in the registry is set to valid at 613. A probe done confirmation message is sent to the OS 602 and the OS sets the device allocation as done at 614. Device deallocation works in a similar manner.

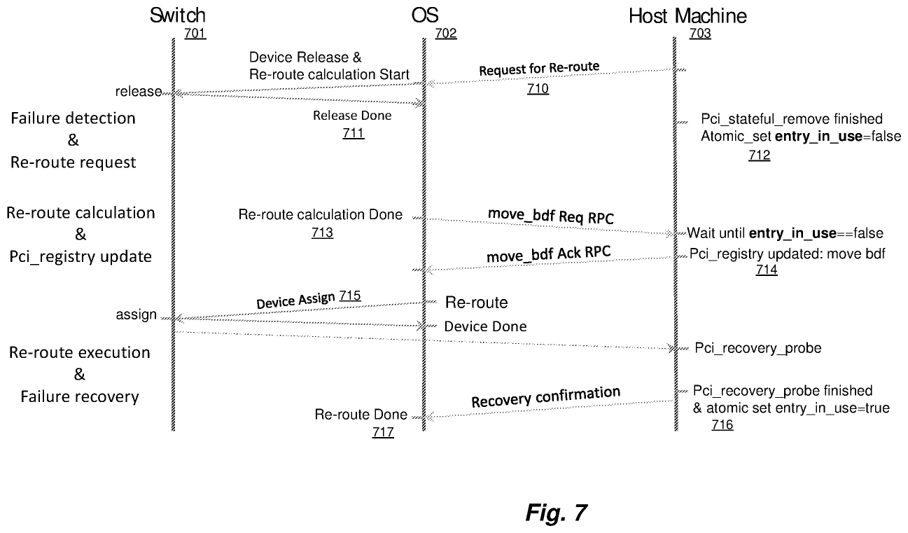

FIG. 7 illustrates an example link failure recovery process according to an embodiment. Host machine 703, running a host software system including the PCIe registry and PCIe driver, may detect a route failure and send a request for a re-route to OS 702 at 710. OS 702 may release the device, start a re-route calculation, and notify switch 701. The release is completed at 711. Host 703 clears the failed route in the PCIe driver. Host may perform a Pci_stateful_remove and sent the entry to false, for example, at 712. When OS 702 completes the re-route calculation at 713, is signals the host 703 to move the BDF entry, which is performed at 714. Host 703 may move at least a portion of the state information describing the failed route from a first BDF address to a second BDF address in the PCIe registry, for example. Upon receiving an ACK from host 703, OS 702 sends a message to reassign the device to switch 701 at 715. After reassignment by switch 701, host 703 may initialize the PCIe driver with the new available route from the second address in the PCIe registry. For example, host 703 may recover a probe at 716. Host 703 may send a message to OS 702 indicating that the re-route is complete at 717.

### Further Examples

Each of the following non-limiting features in the following examples may stand on its own or may be combined in various permutations or combinations with one or more of the other features in the examples below.

In various embodiments, the present disclosure may be implemented as a system (e.g., an electronic computation system), method (e.g., carried out on one or more systems), or a non-transitory computer-readable medium (CRM) storing a program executable by one or more processors, the program comprising sets of instructions for performing certain processes described above or hereinafter.

In one embodiment, the present disclosure includes a computer system comprising: a plurality of processors; a plurality of peripheral devices; a switch network coupled between the plurality of processors and the plurality of peripheral devices, wherein the plurality of processors and plurality of peripheral drivers are configured in a plurality of partitions.

In one embodiment, the present disclosure includes a driver executing on a processor, the driver storing state information, and a registry executing on a processor, the registry storing the state information, wherein the driver reads new state information from the registry when a path between a first processor and a first peripheral device through the switch network changes.

In another embodiment, the present disclosure includes a method of configuring partitioned devices. In yet another embodiment, the present disclosure includes a non-transitory computer-readable medium storing a program executable by one or more processors, the program comprising sets of instructions. The method and/or set of instructions: coupling a plurality of processors and a plurality of peripheral devices together over a peripheral component interconnect express (PCIe) switch network, wherein the plurality of processors and plurality of peripheral drivers are configured in a plurality of partitions; executing a PCIe driver on a first processor of the processors, the PCIe driver storing state information; and executing a PCIe registry on the first processor of the processors, the PCIe registry storing the state information, wherein the PCIe driver reads new state information from the PCIe registry when a path between a first processor and a first peripheral device through the PCIe switch network changes.

In one embodiment, the switch network is a peripheral component interconnect express (PCIe) switch network, the driver is a PCIe driver, and the registry is a PCIe registry.

In one embodiment, the state information is routing information.

In one embodiment, the driver reads new routing information from the registry when a route between the first processor and the first peripheral device, through the switch network, in a first partition changes.

In one embodiment, the registry receives routing information from an operating system managing a plurality of partitions of the plurality of processors and the plurality of peripheral devices.

In one embodiment, each partition comprising at least one processor and a first plurality of peripheral drivers coupled together through a portion of the switch network.

In one embodiment, the registry comprises a plurality of routing paths between the processors and peripheral devices.

In one embodiment, each routing path of the plurality of routing paths is stored at a unique address in the registry.

In one embodiment, the plurality of processors and the plurality of peripheral devices in each partition are mapped to the unique addresses in the registry.

In one embodiment, each entry in the registry comprises a field designating that the routing path is reserved, wherein in response to detecting a reserved designation, the routing path is probed to initialize the driver.

In one embodiment, each entry in the registry comprises a field designating that the routing path is valid or invalid, wherein a valid designation has been initialized by the PCIe driver and an invalid designation has not been initialized by the driver.

In one embodiment, further comprising a host software system executing the registry and driver, wherein the host software system: detects a failed route; clears the failed route in the driver; move at least a portion of the state information from a first address to a second address in the registry; and initialize the driver with the new available route from the second address in the registry.

In one embodiment, one or more of the plurality of processors comprise one or more of an x86 processor, an ARM processor, or an artificial intelligence optimized processor.

In one embodiment, one or more of the plurality of peripheral devices comprise one or more of a solid state drive, a graphics processing unit, or a field programmable gate array.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A computer system comprising:
a plurality of processors;
a plurality of peripheral devices;
a switch network coupled between the plurality of processors and the plurality of peripheral devices, wherein the plurality of processors and plurality of peripheral drivers are configured in a plurality of partitions;
a driver executing on a first processor of the processors, the driver storing state information; and
a registry executing on the first processor of the processors, the registry storing the state information,
wherein the driver reads new state information from the registry when a path between a first processor and a first peripheral device through the switch network changes.

2. The system of claim 1, wherein the switch network is a peripheral component interconnect express (PCIe) switch network, the driver is a PCIe driver, and the registry is a PCIe registry.

3. The system of claim 1, wherein the state information is routing information.

4. The system of claim 3, wherein the driver reads new routing information from the registry when a route between the first processor and the first peripheral device, through the switch network, in a first partition changes.

5. The system of claim 3, wherein the registry receives routing information from an operating system managing a plurality of partitions of the plurality of processors and the plurality of peripheral devices.

6. The system of claim 1, each partition comprising at least one processor and a first plurality of peripheral drivers coupled together through a portion of the switch network.

7. The system of claim 1, wherein the registry comprises a plurality of routing paths between the processors and peripheral devices.

8. The system of claim 7, wherein each routing path of the plurality of routing paths is stored at a unique address in the registry.

9. The system of claim 8, wherein the plurality of processors and the plurality of peripheral devices in each partition are mapped to the unique addresses in the registry.

10. The system of claim 7, wherein each entry in the registry comprises a field designating that the routing path is reserved, wherein in response to detecting a reserved designation, the routing path is probed to initialize the driver.

11. The system of claim 7, wherein each entry in the registry comprises a field designating that the routing path is valid or invalid, wherein a valid designation has been initialized by the PCIe driver and an invalid designation has not been initialized by the driver.

12. The system of claim 7, further comprising a host software system executing the registry and driver, wherein the host software system:
detects a failed route;
clears the failed route in the driver;
move at least a portion of the state information from a first address to a second address in the registry; and
initialize the driver with the new available route from the second address in the registry.

13. The system of claim 1, wherein one or more of the plurality of processors comprise one or more of an x86 processor, an ARM processor, or an artificial intelligence optimized processor.

14. The system of claim 1, wherein one or more of the plurality of peripheral devices comprise one or more of a solid state drive, a graphics processing unit, or a field programmable gate array.

15. A method of configuring partitioned devices comprising:
coupling a plurality of processors and a plurality of peripheral devices together over a peripheral component interconnect express (PCIe) switch network, wherein the plurality of processors and plurality of peripheral drivers are configured in a plurality of partitions;
executing a PCIe driver on a first processor of the processors, the PCIe driver storing state information; and
executing a PCIe registry on the first processor of the processors, the PCIe registry storing the state information,
wherein the PCIe driver reads new state information from the PCIe registry when a path between a first processor and a first peripheral device through the PCIe switch network changes.

16. The method of claim 15, wherein the state information is routing information.

17. The method of claim 16, wherein the PCIe registry receives routing information from an operating system managing a plurality of partitions of the plurality of processors and the plurality of peripheral devices.

18. A non-transitory computer-readable medium storing a program executable by one or more processors, the program comprising sets of instructions for:
coupling a plurality of processors and a plurality of peripheral devices together over a peripheral component interconnect express (PCIe) switch network, wherein the plurality of processors and plurality of peripheral drivers are configured in a plurality of partitions;
executing a PCIe driver on a first processor of the processors, the PCIe driver storing state information; and
executing a PCIe registry on the first processor of the processors, the PCIe registry storing the state information,
wherein the PCIe driver reads new state information from the PCIe registry when a path between a first processor and a first peripheral device through the PCIe switch network changes.

19. The non-transitory computer-readable medium of claim 18, wherein the state information is routing information.

20. The non-transitory computer-readable medium of claim 19, wherein the PCIe driver reads new routing information from the PCIe registry when a route between the first processor and the first peripheral device, through the PCIe switch network, in a first partition changes.
